(19) United States
(12) Patent Application Publication
(10) Pub. No.: US 2023/0392449 A1
(43) Pub. Date: Dec. 7, 2023

(54) COUPLINGS AND COUPLING SYSTEMS

(71) Applicant: Halliburton Energy Services, Inc., Houston, TX (US)

(72) Inventors: Ketankumar Kantilal SHETH, Tulsa, OK (US); Donn Jason BROWN, Tulsa, OK (US); Randy Louis MATHES, Tulsa, OK (US)

(73) Assignee: Halliburton Energy Services, Inc., Houston, TX (US)

(21) Appl. No.: 17/831,192

(22) Filed: Jun. 2, 2022

(51) Int. Cl. E21B 17/02; E21B 43/12

(52) U.S. Cl. CPC E21B 17/02; E21B 43/128

(57) ABSTRACT

A coupling includes an inner surface configured to receive a shaft of an electric submersible pump system through the inner surface. The coupling also includes an outer surface having a torsional undercut into the coupling, where the torsional undercut is configured to induce a failure of the coupling prior to a failure of the shaft.

### BACKGROUND

The present disclosure relates generally to couplings and coupling systems.

Fluid, such as gas, oil or water, is often located in underground formations. When pressure within the well is not enough to force fluid out of the well, the fluid must be pumped to the surface so that it can be collected, separated, refined, distributed and/or sold. Centrifugal pumps are typically used in electric submersible pump (ESP) applications for lifting well fluid to the surface.

### BRIEF DESCRIPTION OF THE DRAWINGS

Illustrative embodiments of the present disclosure are described in detail below with reference to the attached drawing figures, which are incorporated by reference herein, and wherein:

FIG. 1 is a perspective view of an electric submersible pump (ESP) assembly;

FIG. 2 is a perspective view of a section of the ESP assembly of FIG. 1, and having two couplings configured to receive a shaft of the ESP assembly;

FIG. 3A is a schematic, cross-sectional view of a coupling similar to the couplings of FIG. 2;

FIG. 3B is a schematic, top-down view of the coupling of FIG. 3A;

FIG. 4A is a schematic, cross-sectional view of another coupling similar to the couplings of FIG. 2;

FIG. 4B is a schematic top-down view of the coupling of FIG. 4A from a first end of the coupling;

FIG. 4C is a schematic top-down view of the coupling of FIG. 4A from a second end of the coupling;

FIG. 5A is a schematic, cross-sectional view of a coupling similar to the coupling of FIG. 3A;

FIG. 5B is a schematic, top-down view of the coupling of FIG. 5A;

FIG. 6A is a schematic, cross-sectional view of another coupling similar to the coupling of FIG. 4A;

FIG. 6B is a schematic top-down view of the coupling of FIG. 6A from a first end of the coupling; and

FIG. 6C is a schematic top-down view of the coupling of FIG. 6A from a second end of the coupling.

The illustrated figures are only exemplary and are not intended to assert or imply any limitation with regard to the environment, architecture, design, or process in which different embodiments may be implemented.

### DETAILED DESCRIPTION

In the following detailed description of the illustrative embodiments, reference is made to the accompanying drawings that form a part hereof. These embodiments are described in sufficient detail to enable those skilled in the art to practice the invention, and it is understood that other embodiments may be utilized and that logical structural, mechanical, electrical, and chemical changes may be made without departing from the spirit or scope of the invention. To avoid detail not necessary to enable those skilled in the art to practice the embodiments described herein, the description may omit certain information known to those skilled in the art. The following detailed description is, therefore, not to be taken in a limiting sense, and the scope of the illustrative embodiments is defined only by the appended claims.

The present disclosure relates to couplings and coupling systems. More particularly, the present disclosure relates to couplings and coupling systems used in ESP systems and assemblies. As referred to herein, a coupling is any device or component configured to couple two or more components or sections, such as two shafts of an ESP system, two sections of a shaft, or two or more other components or sections. The coupling has an inner surface that is configured to receive a shaft of an ESP assembly through the inner surface. The coupling also has an outer surface having a torsional undercut in the outer surface of the coupling, where the torsional undercut induces a failure (failure due to torsional stress, shearing, or other types of stress-related failure) of the coupling prior to damage to or failure of the shaft, or another component of the ESP assembly. In some embodiments, failure of the coupling prior to damage to or failure of the shaft is automatically determined or manually determined by an operator, and operations performed by the ESP assembly are temporarily suspended before the shaft fails to replace the coupling, which takes significantly less time and resources than replacing the shaft if the shaft fails.

In some embodiments, the torsional undercut is formed to have a length, depth, width, shape (e.g., rectangular, helical, or another shape), and/or dimensions to reduce a strength (e.g., a torsional strength, a shear strength, or another measurement indicative of resistance to failure) of the coupling to be less than the strength of the shaft such that the coupling is configured to fail prior to the shaft. In one or more of such embodiments, the torsional undercut is formed such that the torsional strength of the coupling at a location of the torsional undercut is approximately between 97%-99% of the torsional strength of the shaft at or near the corresponding location of the torsional undercut, such that the coupling will fail before the shaft is damaged or fails. In one or more of such embodiments, the torsional undercut is formed such that the torsional strength of the coupling at a location of the torsional undercut is approximately between 90%-99% of the torsional strength of the shaft. In some embodiments, the coupling has a shear strength at a location of the torsional undercut that is approximately between 97%-99% of the shear strength of the shaft at or near the corresponding location of the torsional undercut, such that the coupling will fail before the shaft fails.

In some embodiments, where the shaft is a spline with an even number of teeth, such as a 6 tooth spline, the inner surface of the coupling has a corresponding number of grooves that are configured to receive the shaft such that each tooth of the spline fits within a corresponding groove of the inner surface. Similarly, in some embodiments, where the shaft is a spline with an odd number of teeth, such as a 7 tooth spline, the inner surface of the coupling has a corresponding number of grooves that are configured to receive the shaft such that each tooth of the spline of the shaft fits within a corresponding groove of the inner surface. In some embodiments, the outer surface of the coupling also has one or more additional torsional undercuts along the outer surface. In one or more of such embodiments, each torsional undercut of the additional torsional undercuts is configured to individually or collectively induce a failure of the coupling prior to a failure of the shaft.

The present disclosure also relates to a coupling configured to receive two different shafts, two different sections of shafts, or other types of components or devices or sections thereof having different outer diameters. More particularly, the coupling has a first inner surface (such as along a first side of the coupling) having a first inner diameter that is configured to receive a first shaft or a first section of a shaft of an ESP assembly in the first inner surface. The coupling also has a second inner surface (such as along a second side of the coupling) having a second inner diameter that is configured to receive a second shaft or a second section of the shaft of the ESP assembly in the second inner surface. For example, the coupling has a first surface that is configured to receive a first shaft having a one inch outer diameter from the first side of the coupling, and to receive a second shaft having an 11/16 inch outer diameter from the second side of the coupling. In some embodiments, the first and second inner surfaces have grooves, each configured to receive a corresponding tooth of shafts that have one or more teeth. The coupling also has a recess formed along the second inner surface, and a pin that is fitted (such as press-fitted) into the recess, where the pin is positioned in between the second inner surface and the second shaft, and where the pin is configured to fail prior to a failure of the first shaft or the second shaft.

In some embodiments, the pin has a torsional strength at a location of the pin that induces a failure at the location of the pin prior to damage to or failure of the first shaft or the second shaft. In some embodiments, failure of the pin prior to damage to or failure of the first shaft or the second shaft is automatically determined or manually determined by an operator, and operations performed by the ESP assembly are temporarily suspended before the shaft fails to replace the coupling, which takes significantly less time and resources than replacing either shaft. In some embodiments, the pin is formed to have a length, depth, width, shape (e.g., rectangular, helical, or another shape), dimensions, and/or materials such that the strength (e.g., a torsional strength, a shear strength, or another measurement indicative of resistance to failure) of the pin is less than the strength of the shaft, where the pin is configured to fail prior to damage to or failure of either shaft. Similarly, the length, width, and dimensions of the recess are selected to receive a pin having a corresponding shape that is configured to fail prior to damage to or failure of either shaft.

In one or more of such embodiments, the pin is formed from materials or is formed to have a dimension such that the torsional strength of the pin at a location of the pin is approximately between 97%-99% of the torsional strength of the second shaft at or near the corresponding location of the pin, such that the pin will fail before the second shaft fails. In one or more of such embodiments, the pin is formed from materials or is formed to have a dimension such that the torsional strength of the pin at a location of the pin is approximately between 90%-99% of the torsional strength of the second shaft at or near the corresponding location of the pin, such that the pin will fail before the second shaft fails. In some embodiments, where the first shaft and the second shaft are splines, each with an even number of teeth, such as a 6 tooth spline, the inner surfaces of the coupling have a corresponding number of grooves that are configured to receive the first shaft and the second shaft such that each tooth of the splines of the first shaft and the second shaft fits within a corresponding groove of the inner surfaces. Similarly, in some embodiments, where the first shaft and the second shaft are splines, each with an odd number of teeth, such as a 7 tooth spline, the inner surfaces of the coupling has a corresponding number of grooves that are configured to receive the first shaft and the second shaft such that each tooth of the splines of the first shaft and the second shaft fits within a corresponding groove of the inner surfaces. In some embodiments, the first shaft is a spline having an odd number of teeth, whereas the second shaft is a spline having an even number of teeth, and the inner surfaces of the coupling have a corresponding number of grooves to receive the first shaft and the second shaft. In some embodiments, the outer surface of the coupling also has one or more torsional undercuts along the outer surface. In one or more of such embodiments, each torsional undercut of the one or more torsional undercuts is configured to individually or collectively induce a failure of the coupling prior to damage to or failure of the first shaft or the second shaft.

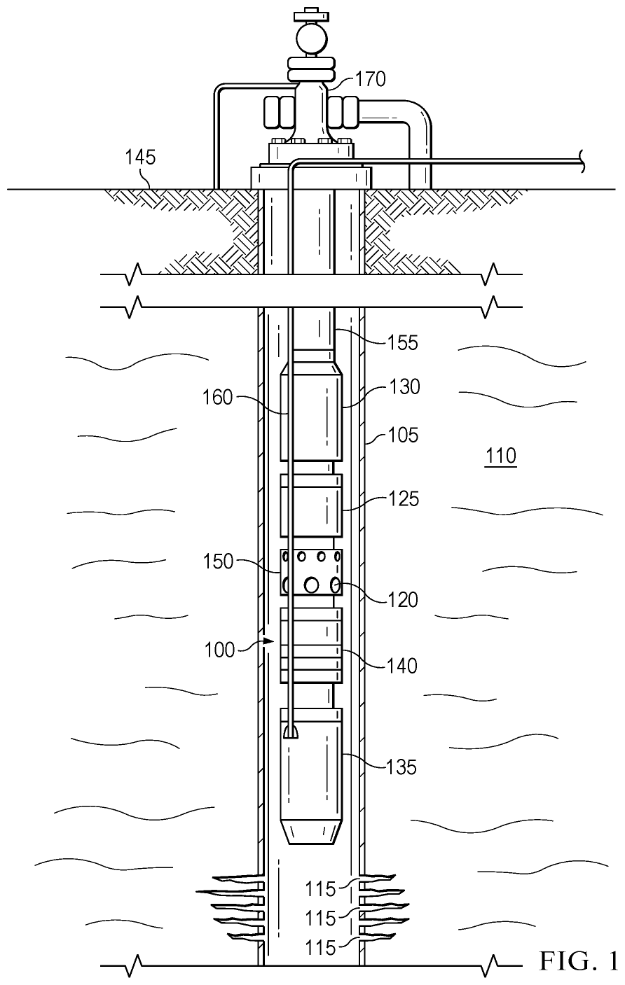

The present disclosure also relates to a coupling system having one or more couplings that are positioned along different joints or sections of the ESP assembly. The coupling system includes any combination of the different types of couplings described herein including, but not limited to, couplings having an inner surface configured to receive one or more shafts having similar or identical outer diameters, and couplings having different inner surfaces and configured to receive shafts or components of shafts having different outer diameters. Additional descriptions of couplings and coupling systems are provided in the paragraphs below and are illustrated in FIGS. 1-6C.

Turning now to the figures, FIG. 1 is a perspective view of an ESP assembly. In the embodiment of FIG. 1, ESP assembly 100 is positioned within a well casing 105, which separates ESP assembly 100 from an underground formation 110. Well fluid enters well casing 105 through perforations 115 and travel downstream to intake ports 120. Intake ports 120 serve as the fluid intake for ESP assembly 100 and are located on an ESP intake section and/or are integral to a gas separator 150. In some embodiments, gas separator 150 is a vortex or rotary type separator and configured to separate gas from the well fluid after intake of the fluid into ESP assembly 100, but prior to the fluid entering a pump 130. ESP assembly 100 includes an ESP pump 130 and a motor 135. In the embodiment of FIG. 1, motor 135 is an electric submersible motor that operates to turn ESP pump 130. In some embodiments, motor 135 is a multi-pole induction motor, such as a two-pole, three-phase squirrel cage induction motor. ESP assembly 100 also includes a power cable 160 configured to provide power to motor 135 and connect to a power source on surface 145. ESP assembly 100 also includes a seal section 140, such as a motor protector, configured to equalize pressure and keep motor oil separate from well fluid. In some embodiments, ESP pump 130 is a multi-stage centrifugal pump having stacked impeller and diffuser stages, and configured to lift fluid to surface 145. ESP assembly 100 also includes a production tubing 155 configured to carry pumped fluid to a wellhead 170 and/or surface 145, and then into a pipeline, storage tank, transportation vehicle and/or other storage, distribution or transportation means. In gassy wells, charge pump 125 may be employed as a lower tandem pump to boost fluid before it enters production ESP pump 130. Charge pump 125 may reduce the net positive suction head required, allowing ESP pump 130 to operate in low inflow pressure conditions that may be caused by gas ingress.

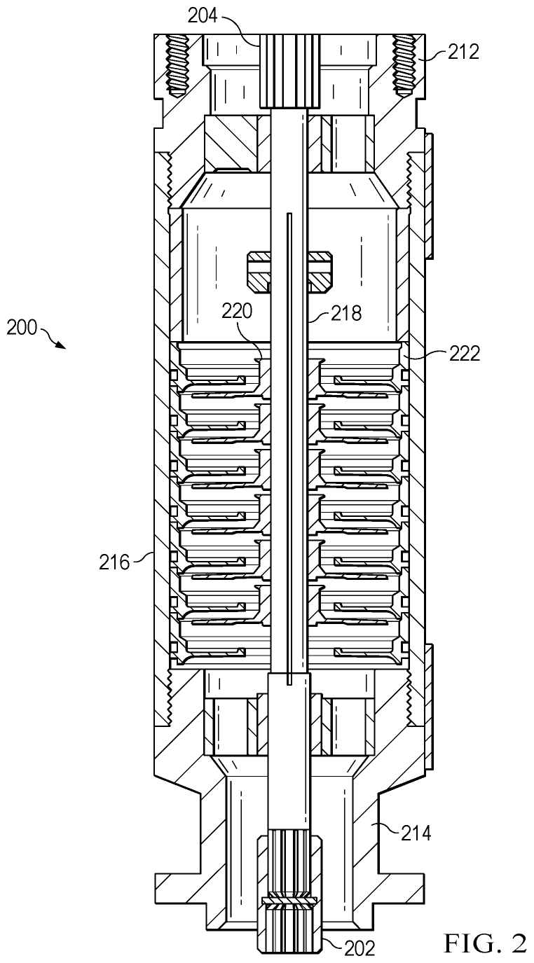

FIG. 2 is a perspective view of a section 200 of ESP assembly 100 of FIG. 1, and having two couplings 202 and 204 configured to receive a rotating shaft 218 of ESP assembly 100. Section 200 includes a rotating impeller 220 and a stationary diffuser 222 that are positioned within a housing 216. A rotating shaft 218 runs through a hub of impeller 220 and diffuser 222. A pump, such as ESP pump 130 of FIG. 1, imparts energy to a fluid by accelerating the fluid through impeller 220. A motor, such as motor 135 of FIG. 1, turns shaft 218, and impeller 220 is keyed to shaft 218, causing impeller 220 to rotate with shaft 218. A first coupling 202 is positioned near a base 214, and a second coupling 204 is positioned near a head 212 of section 200 to reduce the likelihood of damage or failure of shaft 218 during operations of ESP assembly 100. More particularly, couplings 202 and 204 are configured to fail (such as due to rotational, torsional, translational, or other types of stress) prior to damage to or failure of shaft 218. In some embodiments, couplings 202 and 204 are configured to have a torsional strength of 97%-99% of the corresponding torsional strength of shaft 218, such that couplings 202 and 204 are damaged or fail before damage or failure to shaft 218. Operations performed by ESP assembly 100 are stopped after damage to or failure of couplings 202 or 204. Afterwards, section 200 is retrieved, one or more new couplings (not shown) are installed to replace couplings 202 and/or 204, section 200 is run downhole, and operations performed by ESP assembly 100 are resumed. Replacing couplings 202 and 204 is less financially costly compared to replacing shaft 218, and is also less labor and time intensive than replacing shaft 218.

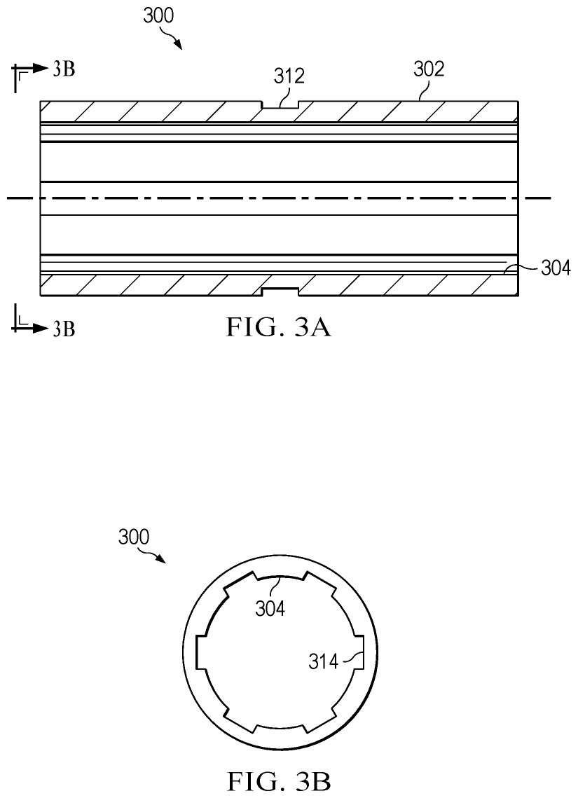

In the embodiment of FIG. 2, couplings 202 and 204 form a coupling system configured to protect shaft 218 by failing before damage to or failure of shaft 218. In some embodiments, the coupling system includes a different number of couplings (not shown) that are placed at different joints of section 200, or at different joints of ESP assembly 100 to protect shaft 218, and other shafts, sections of shafts, and other components and/or sections of components. Illustrations and descriptions of different types of couplings are provided in FIGS. 3A-6C, and the paragraphs herein. Although FIG. 2 illustrates one section 200 of ESP assembly 100, in some embodiments, one or more couplings are installed at junctions of other sections of ESP assembly 100 to prevent damage to or failure of shafts and other components of ESP assembly 100. In some embodiments, one or more of the couplings of the coupling system are similar or identical to coupling 300, 400, 500, or 600 of FIGS. 3A and 3B, 4A-4C, 5A and 5B, or 6A-6C, respectively, whereas one or more of the couplings of the coupling system are similar or identical to another one of coupling 300, 400, 500, or 600 of FIGS. 3A and 3B, 4A-4C, 5A and 5B, or 6A-6C, respectively.

FIG. 3A is a schematic, cross-sectional view of a coupling 300 similar to couplings 202 and 204 of FIG. 2. FIG. 3B is a schematic, top-down view of coupling 300 of FIG. 3A. Coupling 300 is configured to receive a shaft such as shaft 218 of FIG. 2, or another shaft, shaft section, another component, or another section of the component through coupling 300. In the embodiment of FIG. 3A, a torsional undercut 312 is formed along an outer surface 302 of coupling 300. In some embodiments, a torsional cut similar or identical to torsional cut 312 is also made on the inner surface 304 of coupling 300. Further, grooves, such as groove 314 of FIG. 3B are formed along inner surface 304 of coupling 300 to complement a corresponding number of teeth of the shaft that are configured to slide into inner surface 304. Grove 314 may be of any shape—rectangular, involute, square, rectangle, lobe, triangular, hexagonal or any curvilinear shape including, but not limited to, threads. The length, depth, width, shape, and dimensions of torsional undercut 312 are selected to reduce the strength of coupling 300 relative to the shaft, and to induce a failure of coupling 300 prior to damage to or failure of the shaft. In some embodiments, torsional undercut 312 reduces the torsional strength of coupling 300 to 97%-99% of the torsional strength of the shaft. In some embodiments, torsional undercut 312 reduces the torsional strength of coupling 300 to 90%-99% of the torsional strength of the shaft. In some embodiments, torsional undercut 312 reduces the shear strength of coupling 300 to 97%-99% of the shear strength of the shaft. In some embodiments, torsional undercut 312 reduces the shear strength of coupling 300 to 90%-99% of the shear strength of the shaft. In some embodiments, additional torsional undercuts (not shown) are formed along outer surface 302 of coupling 300 to induce a failure of coupling 300 prior to damage to or failure of the shaft. Although FIG. 3B illustrates six grooves formed along inner surface 304 of coupling 300, in some embodiments, a different number of grooves are formed along inner surface 304 to complement a corresponding number of teeth of the shaft.

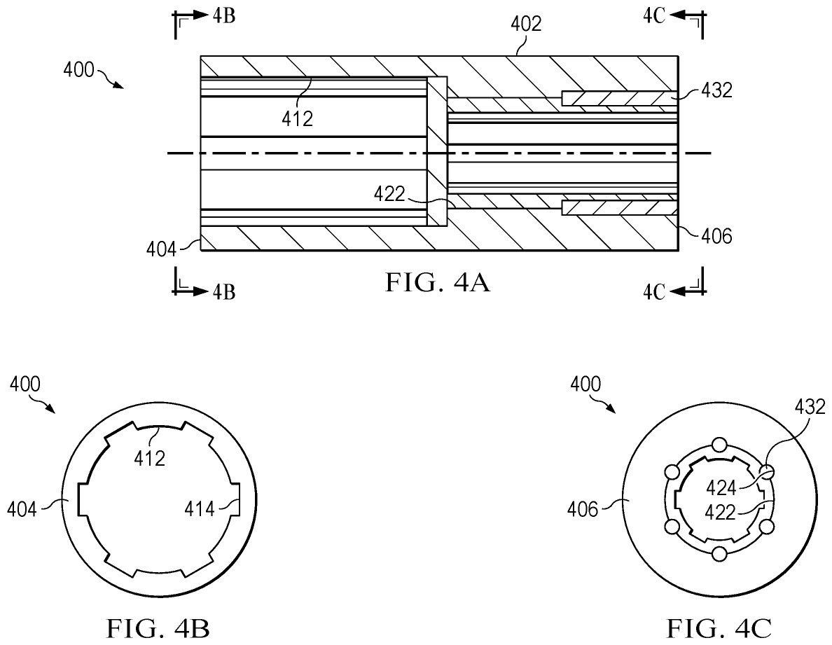

FIG. 4A is a schematic, cross-sectional view of another coupling 400 similar to couplings 202 and 204 of FIG. 2. FIG. 4B is a schematic top-down view of coupling 400 of FIG. 4A from a first end 404 of coupling 400. FIG. 4C is a schematic top-down view of coupling 400 of FIG. 4A from a second end 406 of coupling 400. In the embodiment of FIGS. 4A-4C, coupling 400 has an outer surface 402 and different sized inner surfaces. More particularly, an inner surface 412 of a first section of coupling 400 that extends from first end 404 into coupling 400, has a diameter that is greater than an inner surface 422 of a second section of coupling 400 that extends from second end 406 to permit coupling 400 to receive different sized shafts, shaft sections, or other components or sections of components having different outer diameters. In the embodiment of FIG. 4B, grooves, such as groove 414, are formed along inner surface 412 to complement a corresponding number of teeth of the shaft that are configured to slide into inner surface 412. Further, recesses, such as recesses 424, are formed along inner surface 422 to receive pins, such as pin 432. Pin 432 is fitted into recess 424 and configured to fail before damage to or failure of either shaft or shaft section that is inserted into coupling 400 to prevent or reduce the likelihood of damage to the shafts or shaft sections. Moreover, the length, depth, shape, and dimensions of recess 424, and the length, depth, shape, dimensions, and material properties of pin 432 are selected to reduce the strength of pin 432 relative to either shaft or shaft section that is inserted into coupling 400, and to induce a failure of pin 432 prior to damage to or failure of either shaft or shaft section that is inserted into coupling 400. In some embodiments, recess 424 has a length, a depth, a shape, or a dimension that is based on the torsional strength of the shaft or section of shaft inserted through second end 406. In some embodiments, the torsional strength of pin 432 is 97%-99% of the torsional strength of either shaft or shaft section that is inserted into coupling 400. In some embodiments, the torsional strength of pin 432 is 90%-99% of the torsional strength of either shaft or shaft section that is inserted into coupling 400. In some embodiments, the shear strength of pin 432 is 97%-99% of the shear strength of either shaft or shaft section that is inserted into coupling 400. In some embodiments, the shear strength of pin 432 is 90%-99% of the shear strength of either shaft or shaft section that is inserted into coupling 400. In some embodiments, one or more torsional undercuts (not shown) similar or identical to torsional undercut 312 of FIG. 3A are formed along outer surface 402 of coupling 400 to induce a failure of coupling 400 prior to damage to or failure of either shaft or shaft section that is inserted into coupling 400.

In some embodiments, pin 432 is also configured to provide additional torsional resistivity and to reduce slippage of the shafts or shaft components that are inserted into coupling 400. Although FIG. 4B illustrates six grooves formed along inner surface 412 of coupling 400, in some embodiments, a different number of grooves are formed along inner surface 412 to correspond to the number of teeth of the shaft or shaft section that is inserted from first end 404 of coupling 400. Further, although FIG. 4C illustrates six pins inserted into six recesses, in some embodiments, a different number of pins are inserted into a corresponding number of recesses to induce a failure of the pins prior to damage to or failure of either shaft or shaft section that is inserted into coupling 400.

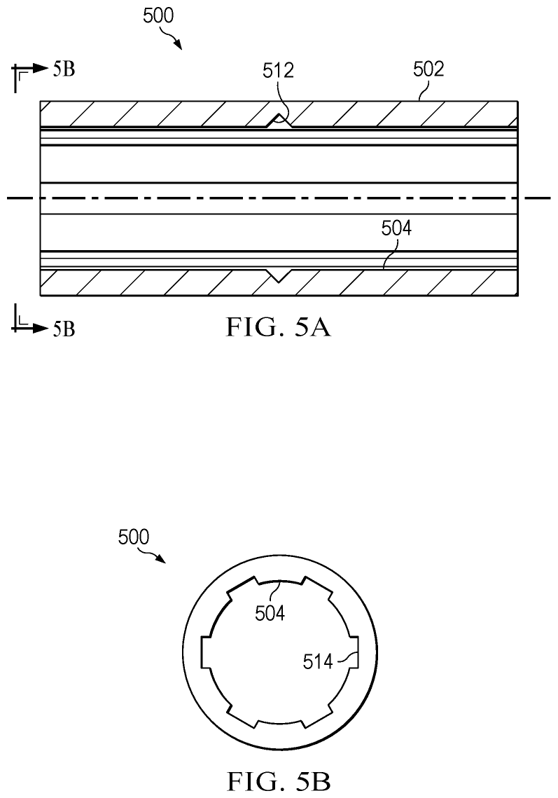

FIG. 5A is a schematic, cross-sectional view of a coupling 500 similar to coupling 300 of FIG. 3A. FIG. 5B is a schematic, top-down view of coupling 500 of FIG. 5A. Coupling 500 is configured to receive a shaft, such as shaft 218 of FIG. 2, or another shaft, shaft section, another component, or another section of the component through coupling 500. In the embodiment of FIG. 5A, a torsional undercut 512 is formed along an inner surface 504 of coupling 500. In some embodiments, a torsional cut similar to torsional undercut 512 is also made on an inner surface 504 of coupling 500. Further, grooves, such as groove 514 of FIG. 5B, are formed along inner surface 504 of coupling 500 to complement a corresponding number of teeth of the shaft that is configured are slide into inner surface 504. Grove 514 may be of any shape—rectangular, involute, square, rectangle, lobe, triangular, hexagonal or any curvilinear shape including, but not limited to, threads. The length, depth, width, shape, and dimensions of torsional undercut 512 are selected to reduce the strength of coupling 500 relative to the shaft, and to induce a failure of coupling 500 prior to damage to or failure of the shaft. In some embodiments, torsional undercut 512 reduces the torsional strength of coupling 500 to 97%-99% of the torsional strength of the shaft. In some embodiments, torsional undercut 512 reduces the torsional strength of coupling 500 to 90%-99% of the torsional strength of the shaft. In some embodiments, torsional undercut 512 reduces the shear strength of coupling 500 to 97%-99% of the shear strength of the shaft. In some embodiments, torsional undercut 512 reduces the shear strength of coupling 500 to 90%-99% of the shear strength of the shaft. In some embodiments, additional torsional undercuts (not shown) are formed along outer surface 502 of coupling 500 to induce a failure of coupling 500 prior to damage to or failure of the shaft. Although FIG. 5B illustrates six grooves formed along inner surface 504 of coupling 500, in some embodiments, a different number of grooves are formed along inner surface 504 to complement a corresponding number of teeth of the shaft.

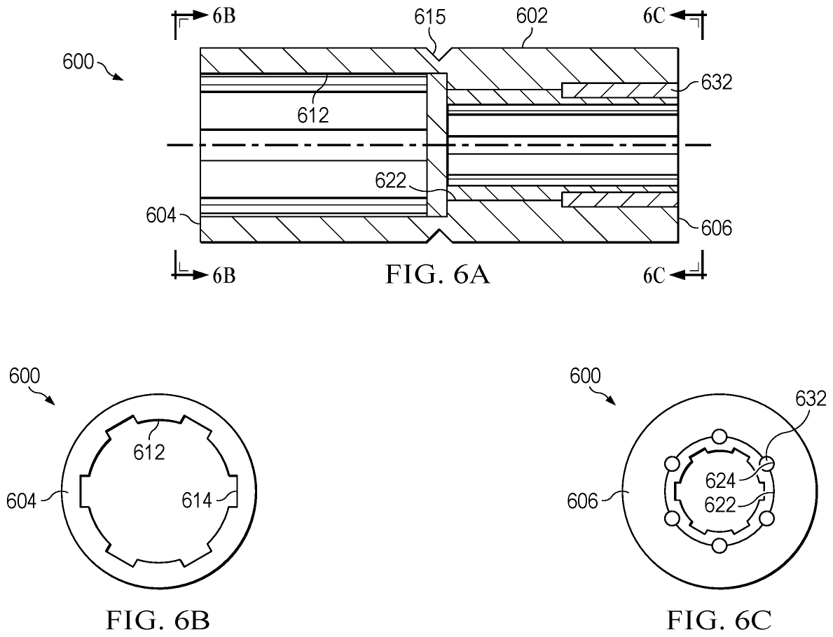

FIG. 6A is a schematic, cross-sectional view of another coupling 600 similar to coupling 400 of FIG. 4A. FIG. 6B is a schematic top-down view of coupling 600 of FIG. 6A from a first end 604 of coupling 600. FIG. 6C is a schematic top-down view of coupling 600 of FIG. 6A from a second end 606 of coupling 600. In the embodiment of FIGS. 6A-6C, coupling 600 has an outer surface 602 having a torsional undercut 615 formed in outer surface 602, and different sized inner surfaces. The length, depth, width, shape, and dimensions of torsional undercut 615 are selected to reduce the strength of coupling 600 relative to the shaft, and to induce a failure of coupling 600 prior to damage to or failure of the shaft. In some embodiments, torsional undercut 615 reduces the torsional strength of coupling 600 to 97%-99% of the torsional strength of the shaft. In some embodiments, torsional undercut 615 reduces the torsional strength of coupling 600 to 90%-99% of the torsional strength of the shaft. In some embodiments, torsional undercut 615 reduces the shear strength of coupling 600 to 97%-99% of the shear strength of the shaft. In some embodiments, torsional undercut 615 reduces the shear strength of coupling 600 to 90%-99% of the shear strength of the shaft. In some embodiments, additional torsional undercuts (not shown) are formed along outer surface 602 of coupling 600 to induce a failure of coupling 600 prior to damage to or failure of the shaft.

In the embodiment of FIGS. 6A-6C an inner surface 612 of a first section of coupling 600 that extends from first end 604 into coupling 600, has a diameter that is greater than an inner surface 622 of a second section of coupling 600 that extends from second end 606 to permit coupling 600 to receive different sized shafts, shaft sections, or other components or sections of components having different outer diameters. In the embodiment of FIG. 6B, grooves, such as groove 614, are formed along inner surface 612 to complement a corresponding number of teeth of the shaft that are configured to slide into inner surface 612. Further, recesses, such as recesses 624, are formed along inner surface 622 to receive pins, such as pin 632. Pin 632 is fitted into recess 624 and configured to fail before damage to or failure of either shaft or shaft section that is inserted into coupling 600 to prevent or reduce the likelihood of damage to the shafts or shaft sections. Moreover, the length, depth, shape, and dimensions of recess 624, and the length, depth, shape, dimensions, and material properties of pin 632 are selected to reduce the strength of pin 632 relative to either shaft or shaft section that is inserted into coupling 600, and to induce a failure of pin 632 prior to damage to or failure of either shaft or shaft section that is inserted into coupling 600. In some embodiments, recess 624 has a length, a depth, a shape, or a dimension that is based on the torsional strength of the shaft or section of shaft inserted through second end 606. In some embodiments, the torsional strength of pin 632 is 97%-99% of the torsional strength of either shaft or shaft section that is inserted into coupling 600. In some embodiments, the torsional strength of pin 632 is 90%-99% of the torsional strength of either shaft or shaft section that is inserted into coupling 600. In some embodiments, the shear strength of pin 632 is 97%-99% of the shear strength of either shaft or shaft section that is inserted into coupling 600. In some embodiments, the shear strength of pin 632 is 90%-99% of the shear strength of either shaft or shaft section that is inserted into coupling 600. In some embodiments, one or more torsional undercuts (not shown) similar or identical to torsional undercut 512 of FIG. 5A are formed along inner surfaces 612 and/or 622 of coupling 600 to induce a failure of coupling 600 prior to damage to or failure of either shaft or shaft section that is inserted into coupling 600.

In some embodiments, pin 632 is also configured to provide additional torsional resistivity and reduce slippage of the shafts or shaft components that are inserted into coupling 600. Although FIG. 6B illustrates six grooves formed along inner surface 612 of coupling 600, in some embodiments, a different number of grooves are formed along inner surface 612 to correspond to the number of teeth of the shaft or shaft section that is inserted from first end 604 of coupling 600. Further, although FIG. 6C illustrates six pins inserted into six recesses, in some embodiments, a different number of pins are inserted into a corresponding number of recesses to induce a failure of the pins prior to damage to or failure of either shaft or shaft section that is inserted into coupling 600.

The above-disclosed embodiments have been presented for purposes of illustration and to enable one of ordinary skill in the art to practice the disclosure, but the disclosure is not intended to be exhaustive or limited to the forms disclosed. Many insubstantial modifications and variations will be apparent to those of ordinary skill in the art without departing from the scope and spirit of the disclosure. The scope of the claims is intended to broadly cover the disclosed embodiments and any such modification. Further, the following clauses represent additional embodiments of the disclosure and should be considered within the scope of the disclosure:
Clause 1, a coupling, comprising: an inner surface configured to receive a shaft of an electric submersible pump assembly through the inner surface; and an outer surface having a torsional undercut into the outer surface of the coupling, wherein the torsional undercut is configured to induce a failure of the coupling prior to a failure of the shaft.
Clause 2, the coupling of clause 1, wherein the coupling has a torsional strength at a location of the torsional undercut that is less than a torsional strength of the shaft at the torsional undercut to induce failure of the coupling prior to the failure of the shaft.
Clause 3, the coupling of clause 2, wherein the torsional strength of the coupling is 97%-99% of the torsional strength of the shaft.
Clause 4, the coupling of clauses 2 or 3, wherein the torsional undercut has a length that is based on the torsional strength of the shaft.
Clause 5, the coupling of any of clauses 2-4, wherein the torsional undercut has a depth that is based on the torsional strength of the shaft.
Clause 6, the coupling of any of clauses 2-5, wherein the torsional undercut has a shape that is based on the torsional strength of the shaft.
Clause 7, the coupling of any of clauses 1-6, wherein the coupling has a shear strength at a location of the torsional undercut that is less than a shear strength of the shaft at the torsional undercut to induce failure of the coupling prior to the failure of the shaft.
Clause 8, the coupling of any of clauses 1-7, wherein the shaft is a spline with an even number of teeth, and wherein the inner surface has a corresponding number of grooves that are configured to fit the even number of teeth of the shaft through the grooves.
Clause 9, the coupling of any of clauses 1-7, wherein the shaft is a spline with an odd number of teeth, and wherein the inner surface has a corresponding number of grooves that are configured to fit the odd number of teeth of the shaft through the grooves.
Clause 10, the coupling of any of clauses 1-9, wherein the outer surface comprises a second torsional undercut into the outer surface of the coupling, and wherein the second torsional undercut is configured to induce a failure of the coupling prior to a failure of the shaft.
Clause 11, a coupling, comprising: a first inner surface having a first inner diameter and configured to receive a first shaft of an electric submersible pump assembly in the first inner surface; a second inner surface having a second inner diameter and configured to receive a second shaft of the electric submersible pump assembly in the second inner surface; a recess formed along the second inner surface; and a pin that is fitted into the recess and in between the second inner surface and the second shaft, and configured to fail prior to a failure of the first shaft or the second shaft.
Clause 12, the coupling of clause 11, wherein the pin has a torsional strength at a location of the pin that is less than a torsional strength of the second shaft to induce failure of the pin prior to the failure of the second shaft.
Clause 13, the coupling of clause 12, wherein the torsional strength of the pin is 97%-99% of the torsional strength of the second shaft.
Clause 14, the coupling of clauses 12 or 13, wherein the recess has a length that is based on the torsional strength of the second shaft.
Clause 15, the coupling of any of clauses 12-14, wherein the recess has a shape that is based on the torsional strength of the second shaft.
Clause 16, the coupling of any of clauses 11-15, further comprising: a second recess formed along the second inner surface; and a second pin that is fitted into the second recess and in between the second inner surface and the second shaft, and is configured to fail prior to the failure of the first shaft or the second shaft.
Clause 17, the coupling of any of clauses 11-16, further comprising an outer surface having a torsional undercut in the outer surface of the coupling, wherein the torsional undercut is configured to induce a failure of the coupling prior to a failure of the first shaft or the second shaft.
Clause 18, a coupling system, comprising: a coupling comprising: a first inner surface having a first inner diameter and configured to receive a first shaft of an electric submersible pump assembly in the first inner surface; a second inner surface having a second inner diameter and configured to receive a second shaft of the electric submersible pump assembly in the second inner surface; and a recess formed along the second inner surface; and a pin that is fitted into the recess and in between the second inner surface and the second shaft, and configured to fail prior to a failure of the first shaft or the second shaft.
Clause 19, the coupling system of clause 18, wherein the pin has a torsional strength at a location of the pin that is less than a torsional strength of the second shaft to induce failure of the pin prior to the failure of the second shaft.
Clause 20, the coupling system of clauses 18 or 19, further comprising: a second coupling comprising: a third inner surface having a third inner diameter and configured to receive a third shaft of the electric submersible pump assembly in the third inner surface; a fourth inner surface having a fourth inner diameter and configured to receive a fourth shaft of the electric submersible pump assembly in the fourth inner surface; and a second recess formed along the fourth inner surface; and a second pin that is fitted into the second recess and in between the fourth inner surface and the fourth shaft, and configured to fail prior to a failure of the third shaft or the fourth shaft.

As used herein, the singular forms “a,” “an,” and “the” are intended to include the plural forms as well, unless the context clearly indicates otherwise. It will be further understood that the terms “comprise” and/or “comprising,” when used in this specification and/or in the claims, specify the presence of stated features, steps, operations, elements, and/or components, but do not preclude the presence or addition of one or more other features, steps, operations, elements, components, and/or groups thereof. In addition, the steps and components described in the above embodiments and figures are merely illustrative and do not imply that any particular step or component is a requirement of a claimed embodiment.

What is claimed is:

1. A coupling, comprising:
an inner surface configured to receive a shaft of an electric submersible pump assembly through the inner surface; and
an outer surface having a torsional undercut into the outer surface of the coupling,
wherein the torsional undercut is configured to induce a failure of the coupling prior to a failure of the shaft.

2. The coupling of claim 1, wherein the coupling has a torsional strength at a location of the torsional undercut that is less than a torsional strength of the shaft at the torsional undercut to induce failure of the coupling prior to the failure of the shaft.

3. The coupling of claim 2, wherein the torsional strength of the coupling is 97%-99% of the torsional strength of the shaft.

4. The coupling of claim 2, wherein the torsional undercut has a length that is based on the torsional strength of the shaft.

5. The coupling of claim 2, wherein the torsional undercut has a depth that is based on the torsional strength of the shaft.

6. The coupling of claim 2, wherein the torsional undercut has a shape that is based on the torsional strength of the shaft.

7. The coupling of claim 1, wherein the coupling has a shear strength at a location of the torsional undercut that is less than a shear strength of the shaft at the torsional undercut to induce failure of the coupling prior to the failure of the shaft.

8. The coupling of claim 1, wherein the shaft is a spline with an even number of teeth, and wherein the inner surface has a corresponding number of grooves that are configured to fit the even number of teeth of the shaft through the grooves.

9. The coupling of claim 1, wherein the shaft is a spline with an odd number of teeth, and wherein the inner surface has a corresponding number of grooves that are configured to fit the odd number of teeth of the shaft through the grooves.

10. The coupling of claim 1, wherein the outer surface comprises a second torsional undercut into the outer surface of the coupling, and wherein the second torsional undercut is configured to induce a failure of the coupling prior to a failure of the shaft.

11. A coupling, comprising:
a first inner surface having a first inner diameter and configured to receive a first shaft of an electric submersible pump assembly in the first inner surface;
a second inner surface having a second inner diameter and configured to receive a second shaft of the electric submersible pump assembly in the second inner surface;
a recess formed along the second inner surface; and
a pin that is fitted into the recess and in between the second inner surface and the second shaft, and is configured to fail prior to a failure of the first shaft or the second shaft.

12. The coupling of claim 11, wherein the pin has a torsional strength at a location of the pin that is less than a torsional strength of the second shaft to induce failure of the pin prior to the failure of the second shaft.

13. The coupling of claim 12, wherein the torsional strength of the pin is 97%-99% of the torsional strength of the second shaft.

14. The coupling of claim 12, wherein the recess has a length that is based on the torsional strength of the second shaft.

15. The coupling of claim 12, wherein the recess has a shape that is based on the torsional strength of the second shaft.

16. The coupling of claim 11, further comprising:
a second recess formed along the second inner surface; and
a second pin that is fitted into the second recess and in between the second inner surface and the second shaft, and is configured to fail prior to the failure of the first shaft or the second shaft.

17. The coupling of claim 11, further comprising an outer surface having a torsional undercut in the outer surface of the coupling, wherein the torsional undercut is configured to induce a failure of the coupling prior to a failure of the first shaft or the second shaft.

18. A coupling system, comprising:
a coupling comprising:
a first inner surface having a first inner diameter and configured to receive a first shaft of an electric submersible pump assembly in the first inner surface;
a second inner surface having a second inner diameter and configured to receive a second shaft of the electric submersible pump assembly in the second inner surface; and
a recess formed along the second inner surface; and
a pin that is fitted into the recess and in between the second inner surface and the second shaft, and is configured to fail prior to a failure of the first shaft or the second shaft.

19. The coupling system of claim 18, wherein the pin has a torsional strength at a location of the pin that is less than a torsional strength of the second shaft to induce failure of the pin prior to the failure of the second shaft.

20. The coupling system of claim 18, further comprising:
a second coupling comprising:
a third inner surface having a third inner diameter and configured to receive a third shaft of the electric submersible pump assembly in the third inner surface;
a fourth inner surface having a fourth inner diameter and configured to receive a fourth shaft of the electric submersible pump assembly in the fourth inner surface; and
a second recess formed along the fourth inner surface; and
a second pin that is fitted into the second recess and in between the fourth inner surface and the fourth shaft, and is configured to fail prior to a failure of the third shaft or the fourth shaft.
